(19) United States
(12) Patent Application Publication
(10) Pub. No.: US 2006/0198033 A1
(43) Pub. Date: Sep. 7, 2006

(54) Fresnel lens sheet

(75) Inventors: Makoto Soyama, Niigata (JP); Masato Fuse, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/367,070

(22) Filed: Mar. 3, 2006

(30) Foreign Application Priority Data
Mar. 4, 2005 (JP) 2005-060956

(51) Int. Cl. G02B 3/08

(52) U.S. Cl. 359/742

(57) ABSTRACT

The Fresnel lens sheet has a plurality of prisms arranged concentrically. The plurality of prisms consists of discontinuous concentric circles in a random mosaic manner. The plurality of prisms may have various circumferential widths. In two radially adjacent prisms of the plurality of prisms, circumferential ends of one prism may not be extensions of the end of the other inner or outer adjacent prism. Two circumferentially adjacent prisms of the plurality of the prisms may be different in distance from the center of the Fresnel circle from each other.

### CROSS REFERENCE TO RELATED APPLICATION

The present application claims priority from a Japanese Patent Application No. 2005-060956 filed on Mar. 4, 2005, the contents of which are incorporated herein by reference.

### BACKGROUND OF THE INVENTION

1. Field of the Invention

The present invention relates to a Fresnel lens sheet. More particularly, the present invention relates to a Fresnel lens sheet having a plurality of prisms arranged concentrically.

2. Related Art

When light passes through optical components which have a plurality of an interval convex/concavo structure such as a Fresnel lens sheet or a lenticular lens sheet, the light changes the intensity in certain interval. The light transmitting through several such optical components as changing its intensity in interval causes light interference which generates moire patterns. Such moire decreases the image quality. To solve the moire problem, conventional documents disclose that each optical component has patterned structures which are arrayed in a certain pitch so that the moire is obscured as disclosed, for example, in Japanese laid-open patent 1994-250291.

The moire cannot be eliminated by the way disclosed in the above prior art document. Further development of eliminating moire is needed.

### SUMMARY OF THE INVENTION

To solve the above problem, the first embodiment of the present invention provides a Fresnel lens sheet having a plurality of prisms arranged concentrically. The plurality of the prisms consists of the discontinuous concentric circles in a random mosaic manner. Such Fresnel lens is used and assembled with an optical component such as a lenticular lens sheet which emits light with a straight stripe pattern so that the moire can be reduced.

The plurality of prisms may have various circumferential widths. In such case, the prisms are not arranged in interval in circumference, which reduces the moire.

In two radially adjacent prisms in the concentric circles, a circumferential ends of one prism may not be extensions of the circumferential ends of the other inner or outer adjacent prism. In such case, the prisms are not arranged in interval in radial. This can reduce the moire.

In two circumferentially adjacent prisms in the concentric circles, the prisms are different in distance from the center of the concentric circles. In such case, the prisms are more randomly arranged so that the moire can be reduced when the Fresnel lens sheet having such prisms used and assembled with an optical component.

The above summary of the present invention doesn't include all of the necessary features. The sub-combinations of these features may be inventions.

### BRIEF DESCRIPTION OF THE DRAWINGS

FIG. 1 shows a structure of a rear projection display device related to the present invention.

FIG. 2 is a partially enlarged view of the A area shown in FIG. 1 of the screen unit 500.

FIG. 3 is a plan view of the Fresnel lens sheet 200.

FIG. 4 is a sectional view of the Fresnel lens sheet 200.

FIG. 5 is a perspective view of the prisms 22 of the first embodiment near the center of the Fresnel lens sheet 200.

FIG. 6 is a perspective view of the prisms 22 of the first embodiment around the edges of the Fresnel lens sheet 200.

FIG. 7 is a sectional view of around the center of the Fresnel lens sheet 200.

FIG. 8 is a sectional view of around the edges of the Fresnel lens sheet 200.

FIG. 9 is a perspective view of the prisms 22 of the second embodiment near the center of the Fresnel lens sheet 200.

FIG. 10 is a perspective view of the prisms 22 of the second embodiment around the edges of the Fresnel lens sheet 200.

FIG. 11 is a perspective view of the prisms 22 of the third embodiment near the center of the Fresnel lens sheet 200.

FIG. 12 is a perspective view of the prisms 22 of the fourth embodiment near the center of the Fresnel lens sheet 200.

FIG. 13 shows how to make the negative master pattern 30 for the Fresnel lens sheet 200.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

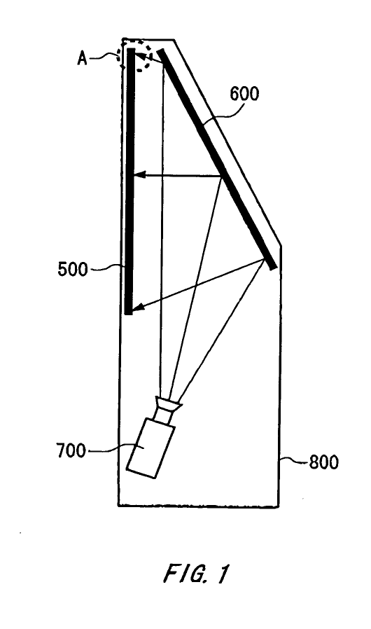

FIG. 1 shows a structure of a rear projection display device 800 related to the present invention. The rear projection display device 800 includes a projection unit 700, a mirror 600, and a screen unit 500. An optical image emitted from the projection unit 700 is reflected on the mirror 600, and reached the screen unit 500. The screen unit 500 spreads the incident optical image toward viewers who are in the viewable zone.

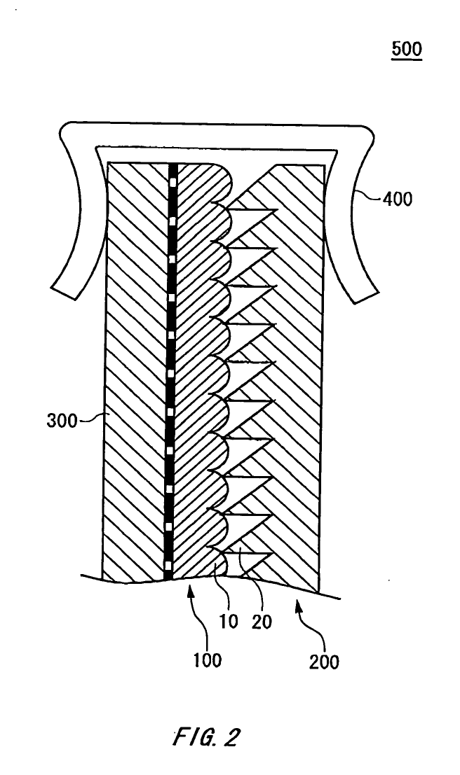

FIG. 2 shows the details of the A area shown in FIG. 1 of the screen unit 500. The screen unit 500 comprises a Fresnel lens sheet 200, a lenticular lens sheet 100, and an outermost optical sheet 300, each of which is parallel to, and adjacent to or close to each other. The Fresnel lens sheet 200 has a plurality of prisms 22 to collimate the light, which is emitted from the projection unit 700, in the approximately perpendicular direction to the screen unit 500. The lenticular lens sheet 100 has a plurality of single hemicylindrical lenses 10 to transmit and diffuse the incident light. The outermost optical sheet 300 protects the lenticular lens sheet 100, and prevents from reflecting outside light on the outside surface thereof which is treated with an anti-glare (AG) coating or an anti-reflection (AR) coating. The outermost optical sheet 300 may diffuse light to extend the viewable zone of the rear projection display device 800. The lenticular lens sheet 100 may be a Fly-Eye lens sheet.

Holding means 400 bind the Fresnel lens sheet 200, the lenticular lens sheet 100, and the outermost optical sheet 300 on the edges thereof. The prisms 22 of the Fresnel lens sheet 200 face the single lenses 10 of the lenticular lens 100. Being total reflecting prisms, the prisms 22 and the single lenses 10 face the same direction. The holding means 400 are arranged at four points around the edges of the screen unit 500. The holding means 400 are made of metal or resin to give grip force to the same. For example, the holding means may be bezels which can be fixed with bolts.

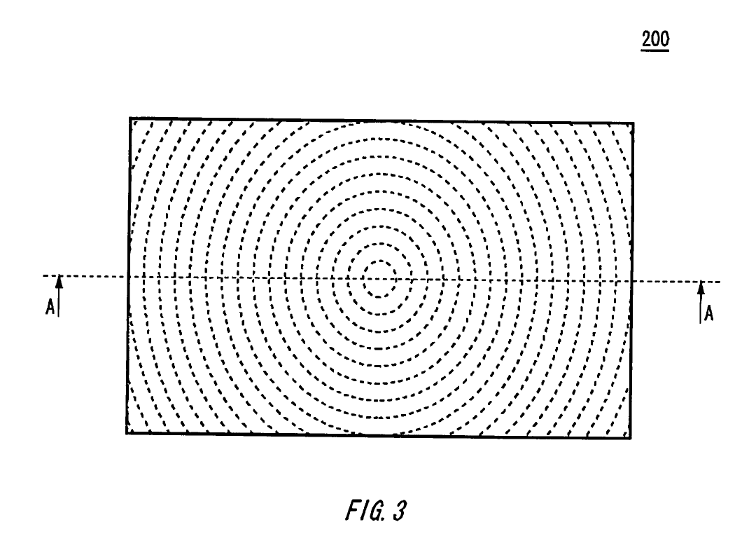

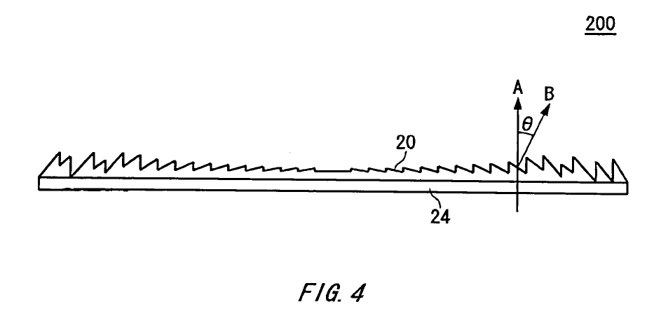

FIG. 3 shows a plan view of the Fresnel lens sheet 200. FIG. 4 shows a sectional view of the Fresnel lens sheet 200 cut on the line A-A shown in FIG. 3. The Fresnel lens sheet 200 has a plurality of prisms 22 arranged concentrically. The plurality of prisms 22 consisting of discontinuous concentric circles in a random mosaic manner. When the Fresnel lens sheet 200 is looked down in the direction of the light axis thereof, the concentric circles appear discontinuously, which consist of the edge lines of the prisms as shown in FIG. 3.

The Fresnel lens sheet 200 has the aspect ratio required by the application thereof. For example, when the Fresnel lens sheet 200 is used for the rear projection display device 800, the aspect ratio of the longitudinal direction to the transverse direction thereof in FIG. 3 is approximately 16:9. Another example of the aspect ratio is approximately 4:3. The height of the outer adjacent prism is larger than that of the inner adjacent prism, as shown in FIG. 4.

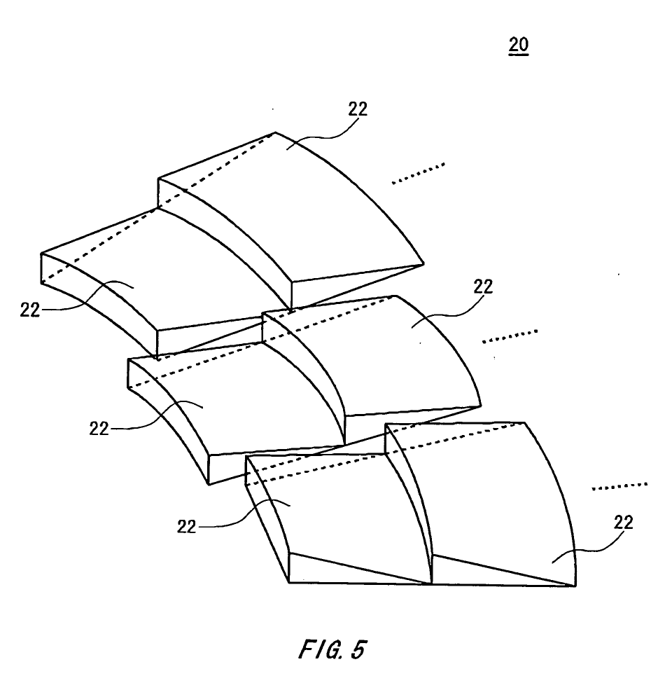

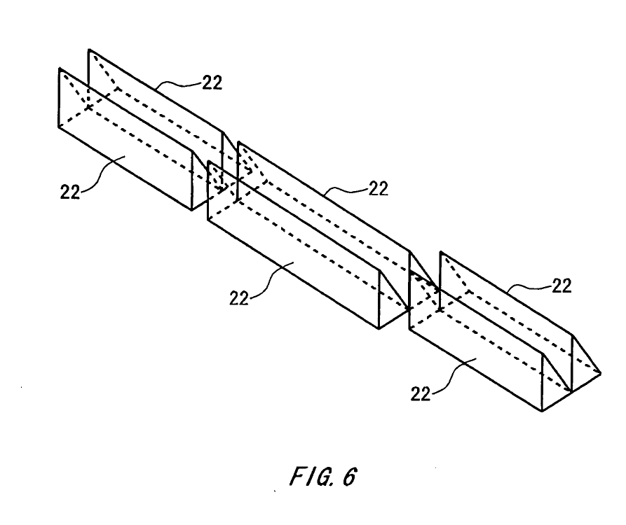

FIGS. 5 and 6 are perspective views of the first embodiment of the plurality of prisms 22. FIG. 5 shows the prisms 22 near the center of the Fresnel lens sheet 200 of the present embodiment. FIG. 6 shows the prisms 22 around the edges of the Fresnel lens sheet 200 of the present embodiment. FIGS. 5 and 6 show only a part of the plurality of the prisms 22. The circumferential curvatures of the prisms 22 are exaggerated in those figures. The angle θ is defined as the angle of the normal line of the slope, or incident/exit surface, of the prism 22, along the direction indicated by the arrow B, against the line which is parallel to the light axis of the Fresnel lens sheet 200. The larger the angle θ is, the farther the normal line of the prism slopes from the light axis of the Fresnel lens sheet 200. When the edge line of the prism 22 is very short than the length of the circumference, the curved lines shown in Figure are deem to be approximately straight. The slope of the prism 22 near the light axis of the Fresnel lens sheet 200 is approximately perpendicular to the light axis thereof. The slope of the prism 22 near the edges thereof is nearly parallel to the light axis thereof. When the Fresnel lens sheet having the plurality of prisms 22 which don't consist of perfect concentric circles is used and assembled with an optical component such as a lenticular lens sheet which emits light with a straight stripe pattern, the moire can be reduced.

In the present embodiment, two circumferentially adjacent prisms 22 are different in distance from the center of the concentric circles. This makes the concentric circles more discontinuous, which further reduces the moire when the Fresnel lens sheet 200 is used and assembled with the optical component.

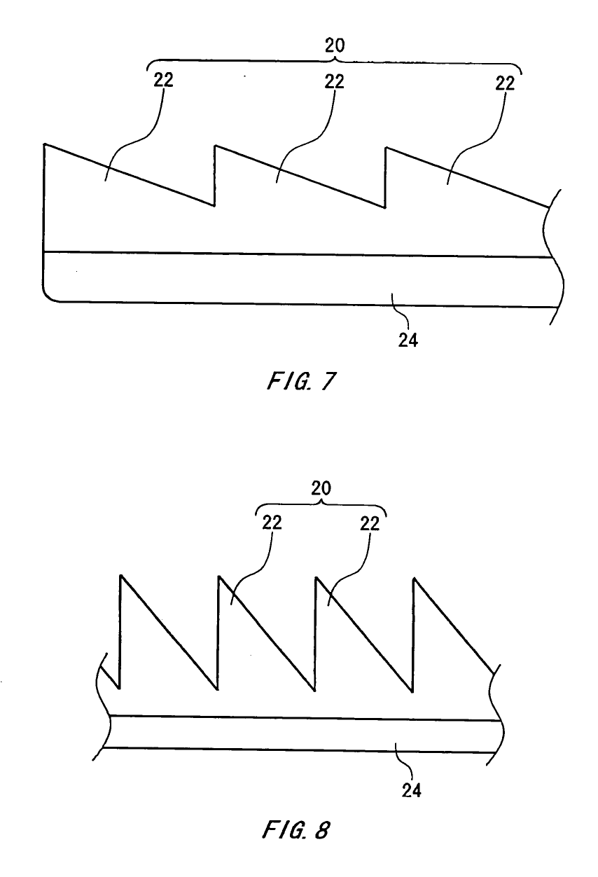

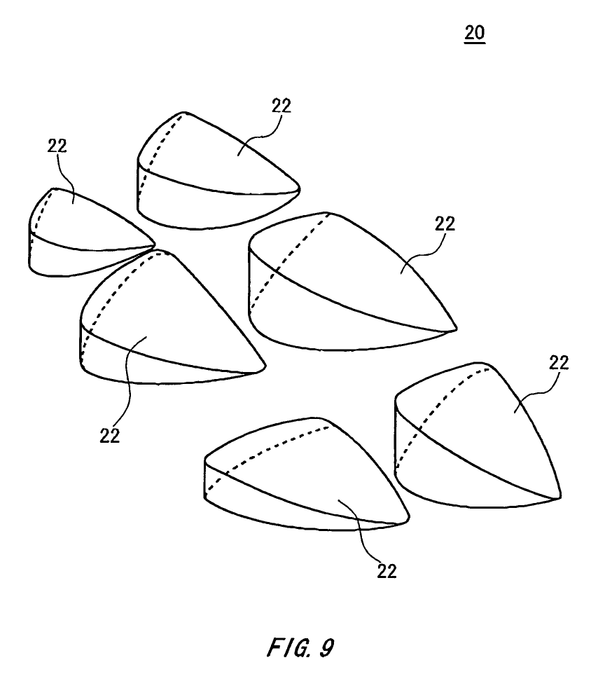

FIGS. 7 and 8 show sectional views of the Fresnel lens sheet 200. FIG. 7 shows a sectional view near the center of the Fresnel lens sheet 200. FIG. 8 shows a sectional view around the edges of the Fresnel lens sheet 200. The Fresnel lens sheet 200 includes a lens portion 20 and a substrate 24. The lens portion 20 of the present embodiment is transparent UV curable urethan acrylate resin, or 2P resin. The substrate 24 is a transparent plastic sheet or a diffuser. The warplessness and strength of the Fresnel lens sheet 200 depend on the material and thickness of the substrate 24. For example, the larger the Fresnel lens sheet 200, the thicker the substrate 24.

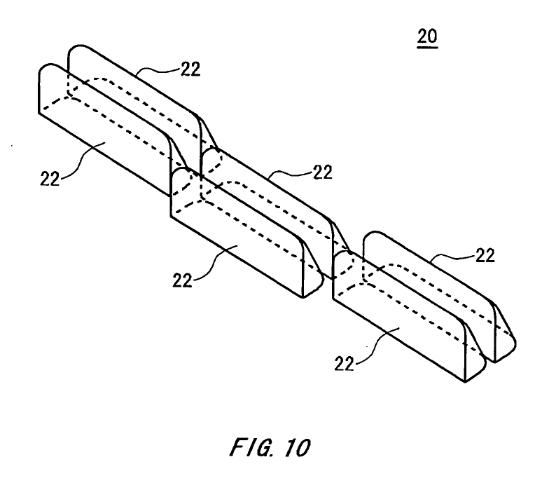

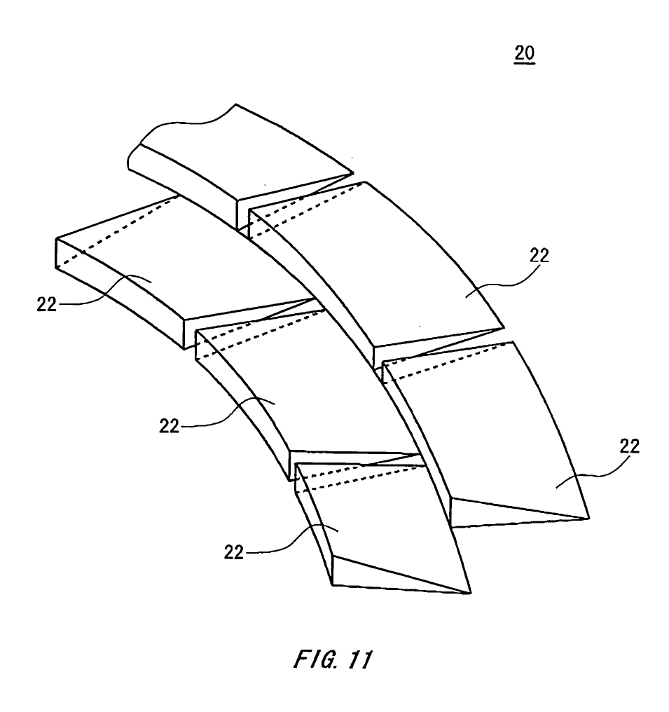

FIGS. 9 and 10 are perspective views of the second embodiment of the plurality of the prisms 22. FIG. 9 shows the prisms 22 near the center of the Fresnel lens sheet 200 of the present embodiment. FIG. 10 shows the prisms 22 around the edges of the Fresnel lens sheet 200 of the present embodiment. The following describes the different point from the embodiment 1. The other points which are not described below are the same as the first embodiment. The description about them is omitted. The prism 22 of the present embodiment has the bottom whose shape is convex to the center of the Fresnel lens sheet 200. This can reduce corners, which tend to generate diffraction of light, so that the generation of ambient light can be reduced. The prisms 22 of the present embodiment can make the negative master pattern 30 for molding the same manufactured easily.

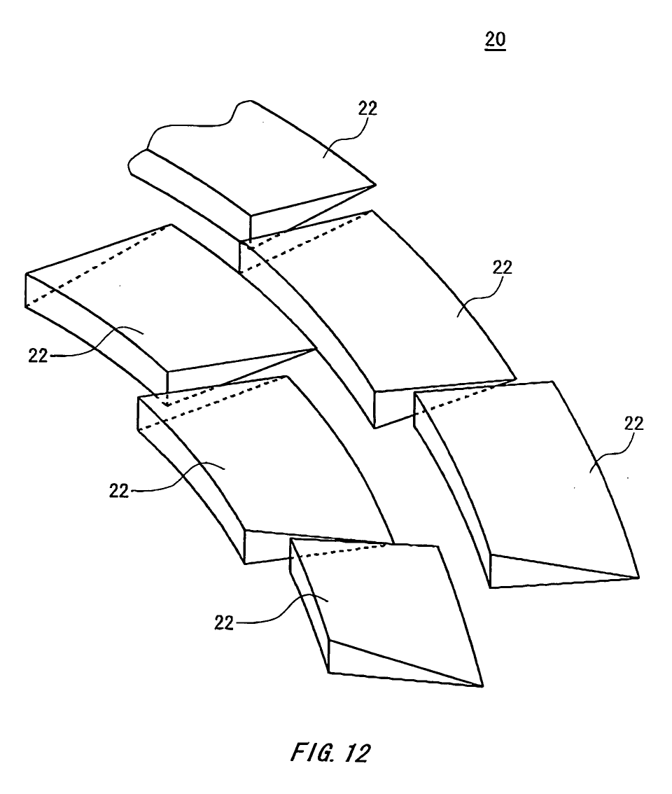

FIG. 11 shows a perspective view of the third embodiment of the plurality of the prisms 22. The following describes the different point from the embodiment 1. The other points which are not described below are the same as the first embodiment. The description about them is omitted. According to the present embodiment, in two radially adjacent prisms 22, the circumferential ends of one prism are not extensions of the circumferential ends of the other inner or outer adjacent prism. In such case, the plurality of prisms 22 isn't arranged in interval in radial. This can reduce the moire.

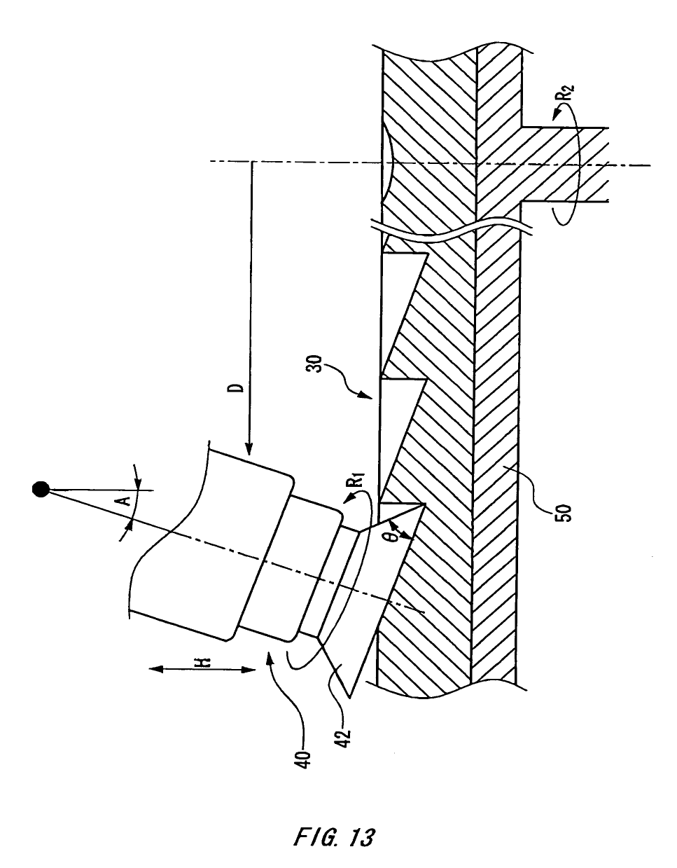

FIG. 12 shows a perspective view of the fourth embodiment of the plurality of the prisms 22. The following describes the different point from the embodiment 1. The other points which are not described below are the same as the first embodiment. The description about them is omitted. According to the present embodiment, in some pairs of the adjacent prisms 22, the circumferential ends of one prism are not extensions of the ends of the other inner or outer adjacent prism, and the distance from the center of the concentric circles of one prism is different from the right or left prism. In such case, the prisms 22 are not arranged in interval in radial. This can reduce the moire.

In the embodiments shown in FIGS. 5, 9, 11, and 12, the rest space on which there is no prism 22 is flat and doesn't contribute the Fresnel lens function. It is preferable, therefore, such flat margin is as small as possible.

The Fresnel lens sheet 200 can be manufactured by a conventional method. The method includes; a resin pouring process in which a resin for lens portion is poured and filled in between a mold and the substrate 24; a resin curing process in which the resin for lens portion is cured to form the Fresnel lens sheet 200; and a mold releasing process in which the cured Fresnel lens sheet 200 is released from the mold.

The negative mold used for molding the Fresnel lens sheet 200 is manufactured by a negative master pattern 30 made of metal, for example. The mold made of epoxy resin is made with a prior art casting method of casting from the negative master pattern 30, for example. FIG. 13 shows how to produce the negative master pattern 30 of the Fresnel lens sheet 200. The negative master pattern 30 is made of metal, and manufactured by cutting work with a machining center and a vertical turning lathe, or other machine tools. The workpiece material for the negative master pattern 30 is held on a rotating table 50. The workpiece on the rotating table 50 rotates against the working head 40 on the rotating axis with the rotation R2. The rotating speed of R2 is, for example, between about 10 rpm and 100 rpm. The working head 40 attaches a smaller cutting tool 42 whose cutting edge has an angle θ which is smaller than the apex angle of the prism 22. The cutting head 40 rotates the cutting tool 42 at the rotating speed of R1. The rotating speed of R1 is about 100 rpm to 10000 rpm, depending on the material of the workpiece.

The machine tool controls three parameters separately to process the negative master pattern 30. The three parameters are; parameter D which relates to the distance from the rotating center of the rotating table 50 to the working head 40, parameter H which relates to the height of a cutting tool 42 from the workpiece, and parameter A which relates to the angle of the rotating axis of the cutting tool 42 against the workpiece. Described below is the procedure of controlling the above parameters when the negative master pattern 30 starts to be processed from the edges. The cutting tool 42 is set with the height parameter H to be separated from the workpiece with enough distance. The angle parameter A of the working head 40 is adjusted so that the slope of the prism 22 around the edge is parallel to the cutting edge of the cutting tool 42. The rotating table 50 is rotated at the speed of R2. The cutting tool 42 is rotated at the speed of R1, and the working head 40 is moved downward. The height parameter H is decreased. When the cutting tool 42 reaches the workpiece, the working head 40 is further moved downward to the distance equal to the height of the prism 22. If the working head 40 is reached the required distance and held in a certain time, it makes the prism 22 have a straight edge line with a certain length as shown in FIG. 10. If the working head 40 is moved upward as soon as it is reached the required distance, it makes the mold cavity for molding the prism 22 having a curved edge line as shown in FIG. 9.

The procedure is repeated until all the prisms on a concentric circle are processed. The working head 40 is then changed the radial distance parameter D so that it is moved in the same distance as the radial pitch of the prism 22 toward the rotating axis of the rotating table 50. The working head 40 is adjusted the angle parameter A so that the slope of the prism 22 is parallel to the cutting edge of the cutting tool 42. The inner adjacent circle of the prisms 22 is processed with the working head 40 controlling the height parameter H to the workpiece in the above procedure. The procedure is repeated to completely process the negative master pattern 30 used for molding the prisms 22 of the second embodiment shown in FIGS. 9 and 10.

The above embodiment is explained how to make the negative master pattern 30 by a cutting work with the machining center. Laser ablation processing may be also used for that purpose.

Apparently from the above description, according to the present embodiment, the Fresnel lens sheet which can be reduced the moire by assembling with an optical component such as a lenticular lens sheet which emits light with a straight stripe pattern is provided.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. A Fresnel lens sheet comprising a plurality of prisms arranged concentrically, wherein said plurality of prisms consists of discontinuous concentric circles in a random mosaic manner.

2. A Fresnel lens sheet according to claim 1, wherein said plurality of prisms has various circumferential widths.

3. A Fresnel lens sheet according to claim 1, wherein in two radially adjacent prisms of the plurality of said prisms in said concentric circles, circumferential ends of one prism of the plurality of said prisms are not extensions of the circumferential ends of the other inner or outer adjacent prism.

4. A Fresnel lens sheet according to claim 1, wherein two circumferentially adjacent prisms of the plurality of said prisms in said concentric circles are different each other in distance from the center of said concentric circles.
